(19) United States
(12) Patent Application Publication
(10) Pub. No.: US 2026/0235165 A1
(43) Pub. Date: Aug. 13, 2026

(54) BEARING SUPPORT BLOCK SYSTEM FOR TELESCOPING TUBES

(71) Applicant: Justin Wang, Palos Verdes Estates, CA (US)

(72) Inventor: Justin Wang, Palos Verdes Estates, CA (US)

(21) Appl. No.: 19/053,237

(22) Filed: Feb. 13, 2025

(51) Int. Cl. F16D 3/06; B25J 17/00; B25J 18/02

(52) U.S. Cl. CPC F16D 3/065; B25J 17/00; B25J 18/025

(57) ABSTRACT

The present devices and methods provide a bearing support block with a tube insertion portion and a bearing support portion. The tube insertion portion is inserted into a tube and fastened therein. The bearing support portion extends from the tube and supports one or more bearings. The tube with the bearing support block of the tube insertion portion fastened therein, is inserted within a dimensionally larger tube in a telescoping arrangement. The bearings slide within the larger tube and contact all inner walls of the larger tube so that the smaller tube can telescope therefrom. A first set of bearings contact opposing interior walls and a second set of bearings contact the adjacent opposing interior walls. Each plate of the bearing block is machined on just one side, so that the plates can be manufactured accurately and cheaply with tools such as a CNC router.

### BACKGROUND

The subject of this patent application relates generally to bearings for telescoping tube assemblies, and more particularly, to bearing blocks which permit smooth extension and retraction of rectangular telescoping tubes.

By way of background, when creating robotic telescoping arms for school robotics competitions or other applications, budget is a primary concern, so that students can participate no matter their background. The telescoping arms should have an appropriate level of accuracy, reliability, reusability, and reconfigurability. In particular, metal bearing blocks and other supports have complex geometry that require expensive machining. Other bearing blocks may be printed, but may lack the reliability and durability required in competition. A simple bearing block design is needed for telescoping arms in inexpensive applications, such as student competitions. Further, the bearing block design should be compact.

Aspects of the present invention fulfill these needs and provide further related advantages as described in the following summary.

### SUMMARY

Aspects of the present invention teach certain benefits in construction and use which give rise to the exemplary advantages described below.

The present specification discloses a bearing support block having a first bearing plate, a second plate, and a third bearing plate. The first bearing plate is arranged parallel to a first plane and includes a first bearing support portion. The second plate is arranged parallel to the first plane and is spaced apart from the first bearing plate. The third bearing plate is arranged parallel to a second plane that is perpendicular to the first plane and includes a third spacer portion extending from a third bearing support portion. When in an assembly, the first bearing plate is fastened with the second plate with the third spacer portion positioned therebetween, where the third spacer portion is held in frictional engagement within the assembly.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is an assembled perspective view of an example embodiment of the present bearing support block system;

FIG. 2 is an exploded perspective view of the bearing support block system of FIG. 1;

FIG. 3 is an assembled perspective view of another example embodiment of the present bearing support block system;

FIG. 4 is a first side view of the bearing support block system of FIG. 3;

FIG. 5 is a second side view of the bearing support block system of FIG. 3;

FIG. 6 is an exploded perspective view of the bearing support block system of FIG. 3;

FIG. 7 is an exploded perspective view of the assembled bearing support block system of FIG. 3, with the bearing support block aligned with and ready for insertion into a rectangular pipe;

FIG. 8 is a perspective view illustrating the bearing support block inserted within the rectangular tube;

FIG. 9 is a perspective view of an example telescoping arm assembly utilizing the bearing support block of FIG. 3;

FIG. 10 is a magnified perspective view of the telescoping arm assembly with the outer tube shown in cutaway to view the bearing support block of FIG. 3;

FIG. 11 is an assembled perspective view of yet another example embodiment of the present bearing support block system; and

FIG. 12 is an exploded perspective view of the bearing support block system of FIG. 11.

The above-described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

The present devices and methods in one or more embodiments provide a bearing support block with a tube insertion portion and a bearing support portion. The tube insertion portion is inserted into a tube, usually with a square profile, and fastened therein. The bearing support portion extends from the tube and supports one or more bearings. The tube with the bearing support block of the tube insertion portion fastened therein, is inserted within a dimensionally larger tube in a telescoping arrangement. There generally is a sufficient number of bearings so that the bearings slide within the larger tube and contact all inner walls of the larger tube so that the tube can telescope from the larger tube. Generally, a first set of bearings contact opposing interior walls and a second set of bearings contact the adjacent opposing interior walls, so that at least four bearings are contacting each of the four respective interior walls. Each plate comprising the bearing block are machined on just one side, so that the plates can be manufactured accurately and cheaply out of appropriate materials, such as aluminum (using standard sheet thicknesses, such as ⅛″, ¼″, and 3/16″) using readily available machining tools, such as a CNC router. The present design permits inexpensive manufacturing, machined within relatively small tolerances to produce a robust bearing block design.

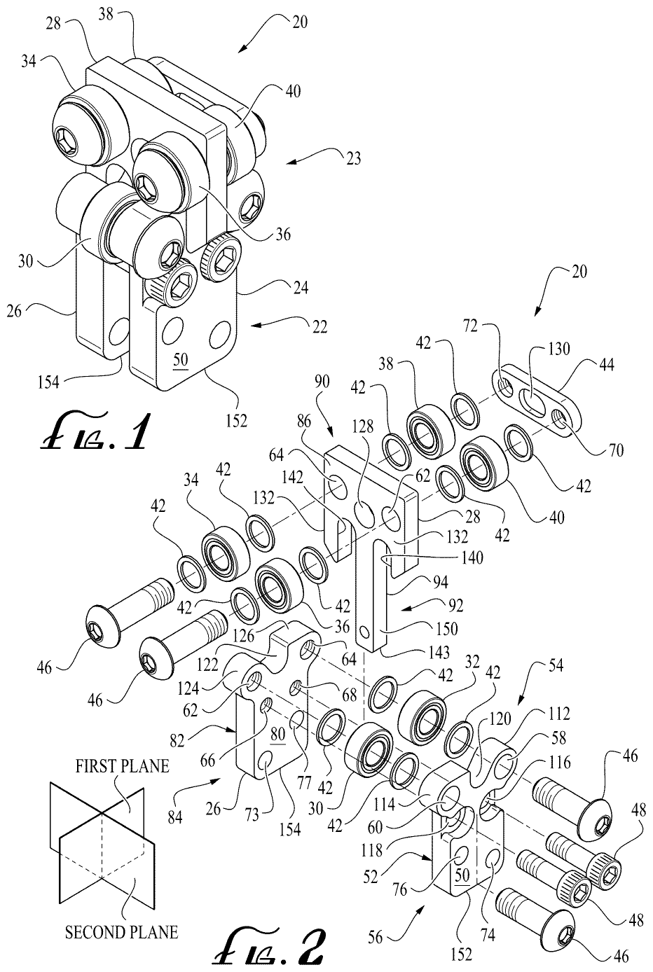

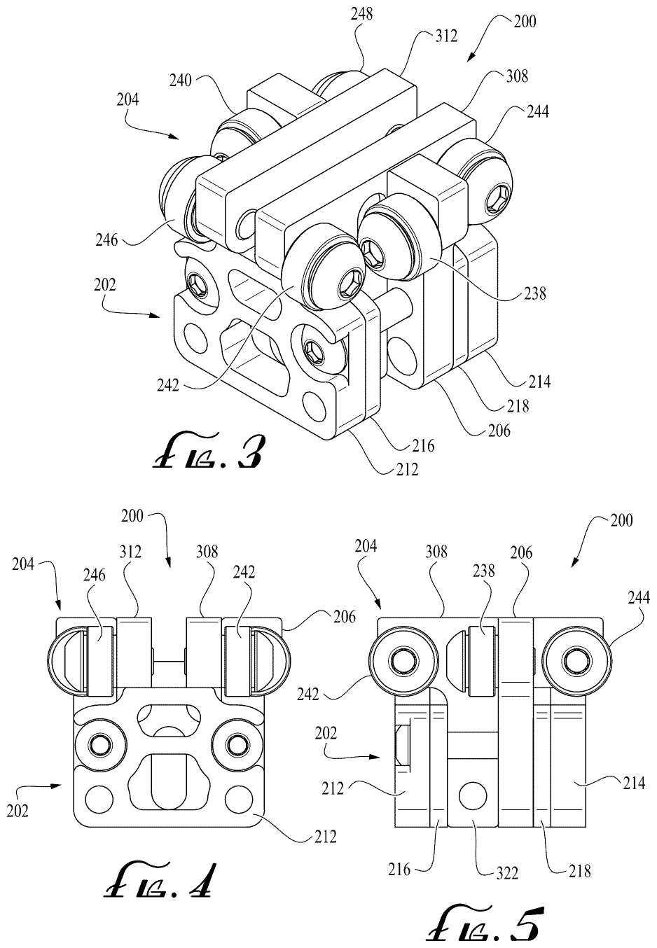

Looking first at FIGS. 1 and 2, an example embodiment of the bearing support block system 20 is illustrated in assembled and exploded configurations, respectively. In one or more embodiments, the bearing support block system 20 includes a plurality of plates 24, 26, 28 fastened together and supporting bearings 30, 32, 34, 36, 38, 40 on a bearing support portion 23 and including a tube insertion portion 22 configured to be fastened within the interior of a tube with the bearing support portion 23 extending from the end of the tube.

In one or more embodiments, a first bearing plate 24 of the present bearing support block system 20 has a first inner planar face 52 that is flat and does not include any machined features, except those features which were created by machining the first outer planar face 50, such as through holes. The first inner planar face 52 is parallel to the first outer planar face, which are both parallel to the first plane. The general shape of the first bearing plate 24 is generally rectangular at the first insert portion 56, with a right ear 112 and a left ear 114 comprising the first bearing support portion 54. The bearing support right ear 112 and the bearing support left ear 114 both extend beyond the perimeter of the first insert portion 56, such that the bearings 30, 32 mounted thereon extend laterally (i.e., to the left and right) beyond the perimeter of the first insert portion 56. Bearing through hole 58 is formed through the right ear 112; and bearing through hole 60 is formed through the left ear 114. The center of the bearing through holes 58, 60 are positioned such that the outer races of bearings 30, 32 mounted thereon extend beyond at least a portion of the ears 112,114 to permit the bearings 30, 32 to roll on opposing inner walls of a square tube without any part of the first bearing plate 24 contacting the square tube, which is discussed in greater detail below. Two fastener countersunk holes 116, 118 are formed through the first insert portion 56, and are countersunk to receive the head of the fastener therein. Tube fastener through holes 74, 76 and 73, 77 are formed through the first insert portion 56 and the second insert portion 84, respectively, which may be threaded to receive a screw therein or unthreaded to receive therein a blind rivet with sufficient space for the blind side expansion. The first bearing plate 24 includes a first plate locating notch 120 formed into the top edge between the first ear 112 and the second ear 114, and at least partially defines the ears 112, 114. The first plate locating notch 120 is configured to receive another plate and restrict movement on one or more axes. A first sidewall of the plate locating notch 120 is vertical (i.e., substantially parallel to the first plane), and an opposing second sidewall of the first plate locating notch 120 is slanted (i.e., cut at an angle relative to the first sidewall and the first plane). All holes 58, 60, 74, 76, 116, 118 are axially formed parallel to the second plane.

In one or more embodiments, a second bearing plate 26 is substantially similar to the first bearing plate 24, except the second bearing plate 26 includes threaded holes 62, 64 for threadably receiving bearing screws 46 therein in place of fastener through holes 74, 76. The second bearing plate 26 is rotated 180 degrees so that the first inner planar face 52 is parallel to and facing the second inner planar face 80, where threaded hole 62 is aligned with through hole 60 and threaded hole 64 is aligned with through hole 58. Fastener countersunk holes 116 is aligned with threaded hole 64, and fastener countersunk holes 118 is aligned with threaded hole 66. The second bearing plate 24 includes a second plate locating notch 122 formed into the top edge between the right ear 124 and the left ear 126, and at least partially defines the ears 124, 126. The second plate locating notch 122 is configured to receive another plate and restrict movement on one or more axes. Like the first bearing plate 24, a first sidewall of the second plate locating notch 122 is vertical (i.e., substantially parallel to the first plane), and an opposing second sidewall of the plate locating notch 120 is slanted (i.e., cut at an angle relative to the first sidewall and the first plane). When the first inner planar surface 52 is arranged parallel and facing the second inner planar face 80, the first plate locating notch 120 is aligned with second plate locating notch 122. However, in this embodiment, the vertical sidewall of one locating notch is opposing the slanted sidewall of the other locating notch. This arrangement provides a lead-in for an easy, guided insertion of a third plate 28, with accurate centering, and permits loosened tolerance in machining. All holes 62, 64, 66, 68, 73, 77 are axially formed parallel to the second plane.

A third bearing plate 24 of the present bearing support block system 20 differs from the first bearing plate 24 and the second bearing plate 26, in that the third bearing plate 24 is designed to be held in frictional engagement between the first bearing plate 24 and the second bearing plate 26. As seen in FIGS. 1 and 2, the planar faces of the first bearing plate 24 and the second bearing plate 26 are parallel to a first plane, while the third bearing plate 24 is parallel to a second plane and normal to the first plane when assembled. The third bearing plate 24 broadly includes a third bearing support portion 90 with an insert portion 92 extending therefrom to form a T-like structure in the present example embodiment. The third bearing plate 24 further includes a third planar face 86 parallel to the second plane when assembled. The third bearing support portion 90 has a right shoulder 132 extending oppositely from a left shoulder 134 in the second plane. The right shoulder 132 has a bearing through hole 62 axially formed parallel to the first plane. The left shoulder 134 has a bearing through hole 64 also axially formed parallel to the first plane. The third bearing support portion 90 includes an optional lanyard hole 128 for threading therethrough a cable, rope, or the like. Beneath the right shoulder 132 is a right locator notch 140. And, beneath the left shoulder 134 is a left locator notch 142. Extending downward and centrally between the right locator notch 140 and the left locator notch 142 is a spacer extension 94, the proximal portion thereof being at least partially defined by the locator notches 140, 142. The spacer extension 94 is rectangular in cross-section and extends downward, like a stem, beyond the notches 140, 142 and terminating at a distal end 143.

Looking at the assembly illustrated in FIGS. 1 and 2, one of many example methods of assembly includes, bringing the first bearing plate 24, the second bearing plate 26, and the third bearing plate 28 into engagement for supporting the bearings on the bearing support portion 23 and creating a tube insertion portion 22. In one example method of assembly, a user can first mount the bearings 34, 36, 38, 40 on the third bearing plate 24. The user can insert the two screws 46 each through their respective bearing assembly, which includes in this order for each of the two screws: a shim 42 (or washer or other means to permit the outer race to rotate without interference), a bearing 34, 36, and another shim 42. The screws 46 are inserted through their respective holes 62, 64 of the third bearing plate 24 with the remainer of the screws extending therethrough. On the planar face opposing the third planar face 86, again, for each respective screw 46, a shim 42, a bearing 38, 40, and another shim 42 are positioned on the screws 46. To complete this subassembly, the screws are threaded into respective threaded holes 70, 72 of a backing plate 44. Once tightened, the screws 46 and the backing plate 44 secure the bearings 34, 36, 38, 40 on the third bearing plate 24. The backer plate 44 additionally includes a lightning recess 130 to reduce weight.

Assembling the third bearing plate 24, with bearings mounted thereon, first bearing plate 24 with the first bearing plate 24 and the second bearing plate 26 can be achieved in one or more method embodiments by loosely assembling the first bearing plate 24 to the second bearing plate 26, then inserting the third bearing plate 24 therebetween. First, screws 46 are each inserted into their respective holes 58, 60, and like above, for each screw 46, a shim 42, a bearing 30, 32, and an additional shim 42 are positioned on the screws 46. Thereafter, screws 46 are threaded loosely into their respective threaded holes 62, 64 of the second bearing plate 26. Further, socket head cap screws 48 are inserted into their respective countersunk holes 116, 118 and loosely threaded into their respective threaded holes 66, 68. In this way, the first bearing plate 24 and the second bearing plate 26 are loosely held together, so that the third bearing plate 28 can be inserted therebetween.

The subassembly of the first bearing plate 24 and the second bearing plate 26 can be set upright on a support surface (or held in the hand), and the spacer extension 94 of the third bearing plate 24 (where the third planar face 86 is parallel to the second plane) is inserted between the first inner planar face 52 and the second inner planar face 80 (which are parallel to the first plane). The spacer extension 94 is inserted between the first bearing plate 24 with the spacer sidewall 150 facing the first inner planar face 52, and the opposing sidewall facing the second inner planar face 80. The spacer extension 94 is inserted between the bearing screws 46 and between the body or block screws 48. In one or more examples, shafts of the body screws 48 are separated by space slightly larger than the thickness of the third bearing plate 24, so that the screws may further limit degrees of freedom available to the spacer extension 94, such as rotation centered on the plate notches 120, 122.

As the spacer extension 94 is inserted, the right locator notch 140 is meshed within plate locating notch 120, and the left locator notch 142 is meshed within plate locating notch 122, in full engagement or partial engagement. In this example embodiment, the distal end 143 of the spacer extension 94 positioned even or flush with the bottom edges 152, 154 of the first bearing plate 24 and the second bearing plate 26, respectively. As the loose assembly is held, screws 46 and screws 48 are tightened, thereby tightly sandwiching the spacer extension 94 therebetween, with the spacer sidewall 150 in frictional engagement with the first inner planar face 52, and the opposing sidewall in frictional engagement with the second inner planar face 80. When fully tightened, the third bearing plate 24 is frictionally held firmly within the assembly.

In the assembled bearing support block system 20, bearings 34, 36, 38, 40 rotate about an axis normal to the second plane and parallel to the first plane, and bearings 30, 32 rotate about an axis normal to the first plane and parallel to the second plane. With this arrangement, the tube insertion portion 22 (comprising the first insert portion 56 of the first bearing plate 24, the second insert portion 84 of the second bearing plate 26, and the third insert portion 92 of the third bearing plate 28) is dimensioned to be inserted into and fastened within a first square tube, preferably without excess play between the first tube and the tube insertion portion 22. Further, bearings 34, 36, 38, 40 are configured to be in rolling contact with a first pair of opposing and parallel walls of a second square tube (slightly larger than the first square tube), and bearings 30, 32 are configured to be in rolling contact with a second pair of opposing and parallel walls that are adjacent to the first set of opposing walls, described in further detail below.

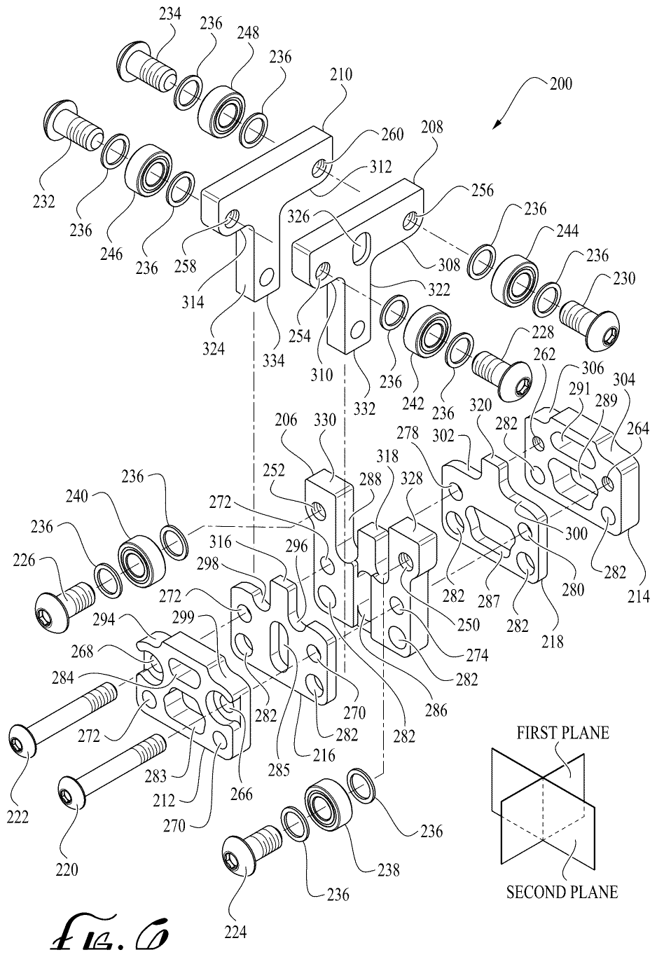

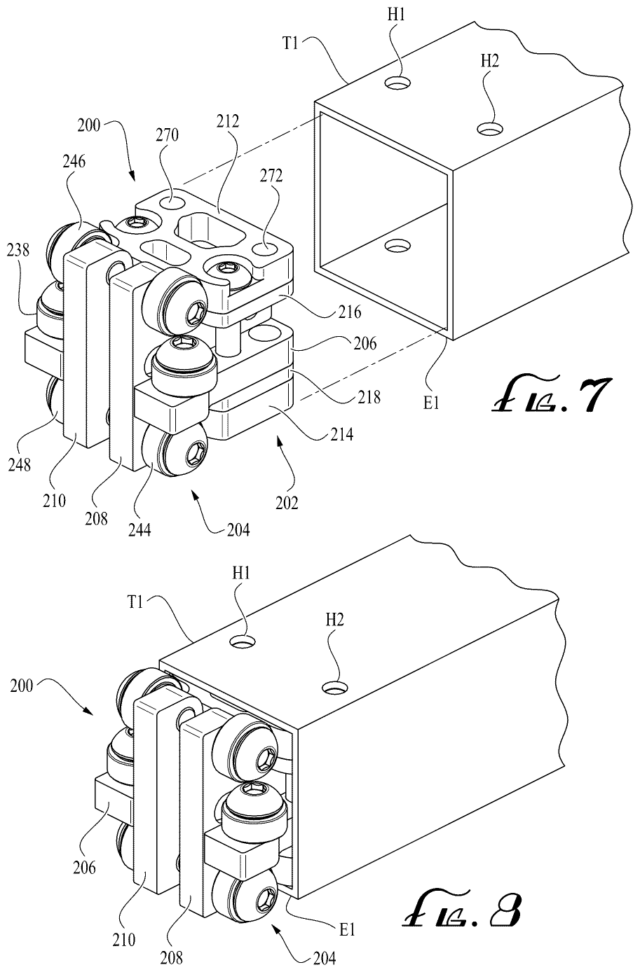

A second example embodiment of the present bearing support block system 200 is illustrated in FIGS. 3-6. This example embodiment substantially similar to the above-described example, in basic structure and operation, in that they are both made of plates machined on one side and stacked together, with two sets of bearings arranged orthogonally to one another facilitated by one or more bearing plates held in frictional engagement between one or more orthogonally arranged plates. The arrangement and number of the various plates are determined by the internal dimensions of a first tube within which it is inserted and the internal dimensions. To accommodate larger internal dimensions, insert or spacer plates can be used, which may or may not include structures for supporting bearings.

The bearing support 200 is illustrated for use with a larger square tube compared to the embodiment of FIGS. 1 and 2. The second bearing plate 208 and the third bearing plate 210 are substantially similar is this example, except they are mirrored. The second bearing plate 208 is T-shaped, with a shoulder 308 extending to the viewer's right and parallel to a first plane, a shoulder 310 extending oppositely to the viewer's left and parallel to the first plane, and a spacer extension 322 extending orthogonally from the shoulders 308, 310 downward and parallel to the first plane. Shoulder 308 includes a threaded hole 256 for receiving threadably therein screw 230. Shoulder 310 includes a threaded hole 254 for receiving threadably therein screw 228. Similar to the prior embodiment, bearing 244 is sandwiched between two shims 236 with screw 230 inserted therethrough to thread into threaded hole 256 and bearing 242 is sandwiched between two shims 236 with screw 228 inserted therethrough to thread into threaded hole 254. A recess between shoulders 308 and 310 serves as a bearing clearance 308 so that bearing 238 may freely rotate. A similar bearing clearance (hidden from view) is found on the third bearing plate 210 so that bearing 240 may freely rotate.

The third bearing plate 210 is T-shaped, with a shoulder 312 extending to the viewer's right and parallel to a first plane, a shoulder 314 extending oppositely to the viewer's left and parallel to the first plane, and a spacer extension 324 extending orthogonally from the shoulders 312, 314 downward and parallel to the first plane. Shoulder 312 includes a threaded hole 260 for receiving threadably therein screw 234. Shoulder 314 includes a threaded hole 258 for receiving threadably therein screw 232. Similar to the prior embodiment, bearing 248 is sandwiched between two shims 236 with screw 234 inserted therethrough to thread into threaded hole 260 and bearing 246 is sandwiched between two shims 236 with screw 232 inserted therethrough to thread into threaded hole 258 to mount bearings 242, 244 and 246, 248 to their respective bearing plates 208 and 210, where, in the assembly, the bearings 242, 244, 246, 248 rotate about axes oriented orthogonally to the first plane.

Bearing 238 and 240 are mounted on the first bearing plate 206, with bearing 238 mounted on first ear 328 and bearing 240 mounted on second ear 330. Plate locating notches 288 and 290 are formed vertically from the top edge of the first bearing plate 206, one spaced apart and parallel to the other, defining a spacer extension 318 therebetween in a W-like shape. Threaded hole 250 is formed through a first ear 328 (adjacent to and partially defined by notch 290) and threaded hole 252 is formed through a second ear 330 (adjacent to and partially defined by notch 288). Two block through holes 274, 276 and two tube fastener through holes 282 are formed through the first bearing plate 206. Plate locating notches 290 and 288 are configured to receive therein shoulders 308 and 312, respectively, when assembled. Lightning hole 286 is centrally formed through the first bearing plate 206 for reducing weight. Spacer extension 316 extends upward and is defined between plate locating notches 288, 290. Screw 224 is inserted through bearing 238 with shims 236 positioned on each side of the bearing 238, where the screw 224 is threaded snugly into threaded hole 250. Likewise, screw 226 is inserted through bearing 240 with shims 236 positioned on each side of the bearing 238, where the screw 226 is threaded snugly into threaded hole 252. In this configuration, bearings 238, 240 are permitted to rotate freely about screws 224, 226.

Viewed from left to right, a first end plate 212 includes countersunk holes 266, 268 for receiving therein block screws 220, 222, respectively. Further, block through holes 270, 272 are formed through the first end plate 212 for receiving therethrough fasteners for attaching the bearing support 200 to a tube. Shoulder clearances 292, 294 are formed on the each of the top corners for providing clearance for shoulders 310, 314 of the second bearing plate 208 and the third bearing plate 210. Lightning holes 283, 284 are centrally formed through the first end plate 212 for reducing weight.

A first spacer plate 216 includes block through holes 270, 272 for receiving therein block screws 220, 222, respectively. Further, block through holes 282 are formed through the first spacer plate 216 for receiving therethrough fasteners for attaching the bearing support 200 to a tube. Shoulder clearances 296, 298 are formed on the top of the first spacer plate 216 for providing clearance for shoulders 310, 314 of the second bearing plate 208 and the third bearing plate 210. Lightning hole 285 is centrally formed through the first spacer plate 216 for reducing weight.

A second spacer plate 218 includes block through holes 278, 280 for receiving therein block screws 222, 220, respectively. Further, block through holes 282 are formed through the second bearing plate 206 for receiving therethrough fasteners for attaching the bearing support 200 to a tube. Shoulder clearances 300, 302 are formed on the top of the first spacer plate 216 for providing clearance for shoulders 308, 312 of the second bearing plate 208 and the third bearing plate 210. Lightning hole 287 is centrally formed through the first spacer plate 216 for reducing weight.

A second end plate 214 includes threaded holes 264, 262 for threadably receiving therein block screws 220, 222, respectively. Further, block through holes 282 are formed through the first bearing plate 206 for receiving therethrough fasteners for attaching the bearing support 200 to a tube. Shoulder clearances 304, 306 are formed on the each of the top corners for providing clearance for shoulders 308, 312 of the second bearing plate 208 and the third bearing plate 210. Lightning holes 289, 291 are centrally formed through the second end plate 214 for reducing weight.

To create an assembled bearing support 200, an example method includes bringing the second bearing plate 208 into engagement with the first bearing plate 206 by inserting shoulder 308 at least partially into plate locating notch 290, with the terminus 332 of the spacer extension 322 even with the bottom edge 336 of the first bearing plate 206. Then, bringing the third bearing plate 210 into engagement with the first bearing plate 206 by inserting shoulder 312 at least partially into plate locating notch 288, with the terminus 334 of the spacer extension 324 even with the bottom edge 336 of the first bearing plate 206. As discussed above, the bearings 238, 240, 242, 244, 246, 248 have been mounted to the first bearing plate 206, the second bearing plate 208, and the third bearing plate 210. The second bearing plate 208 and the third bearing plate 210 will both be arranged separate and parallel to one another and to the first plane, where the separation distance will be at least the width of spacer extension 318 positioned therebetween. Thereafter, the first spacer plate 216 is positioned parallel to the first bearing plate 206, with the spacer extensions 322, 324 sandwiched between the first bearing plate 206 and the first spacer plate 216. Then the first end plate 212 is stacked face-to-face on the first spacer plate 216, with each major face of the plates 206, 212, 216 parallel to the second plane. Block screw 220 is inserted through holes 266, 270, 274, and block screw 222 is inserted through holes 268, 272, 276. While manually holding the block screws 220, 220 in place within the countersunk holes 266, 268, the assembler brings the second spacer plate 218 into face-to-face contact with the first bearing plate 206 by inserting block screw 220 through hole 280 and by inserting block screw 222 through hole 278. Thereafter, the assembler brings the second end plate 214 into face-to-face contact with the second spacer plate 218 by threading block screw 220 into threaded hole 264 and by threading block screw 222 into threaded hole 262. Tightening screws 220, 222 securely clamp spacer extensions 322, 324 between the first spacer plate 216 and the first bearing plate 206, holding the second bearing plate 208 and the third bearing plate 210 in frictional engagement therebetween. Further, assembly can be accomplished using a vice and/or a hammer for press fit joints.

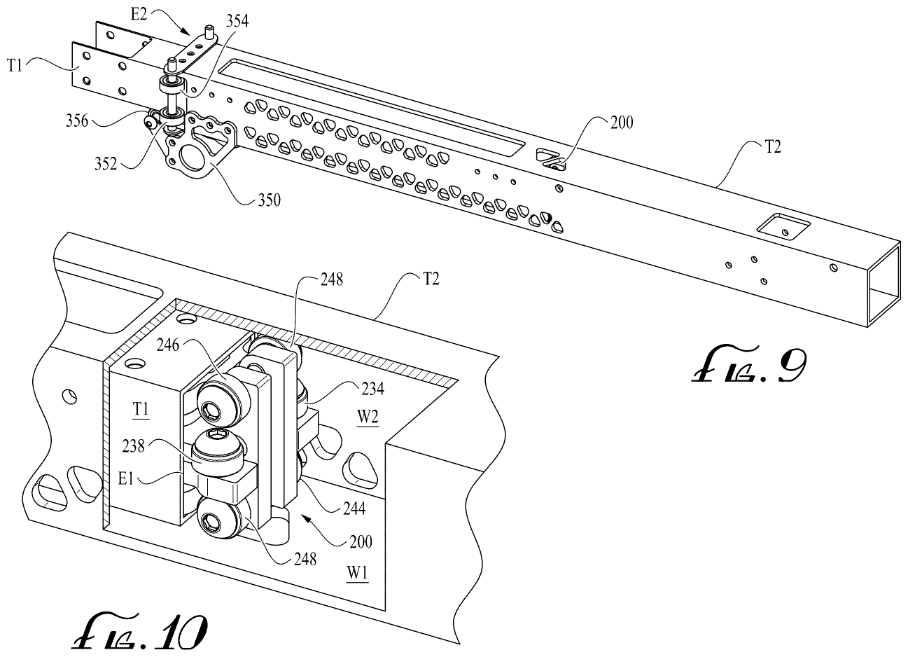

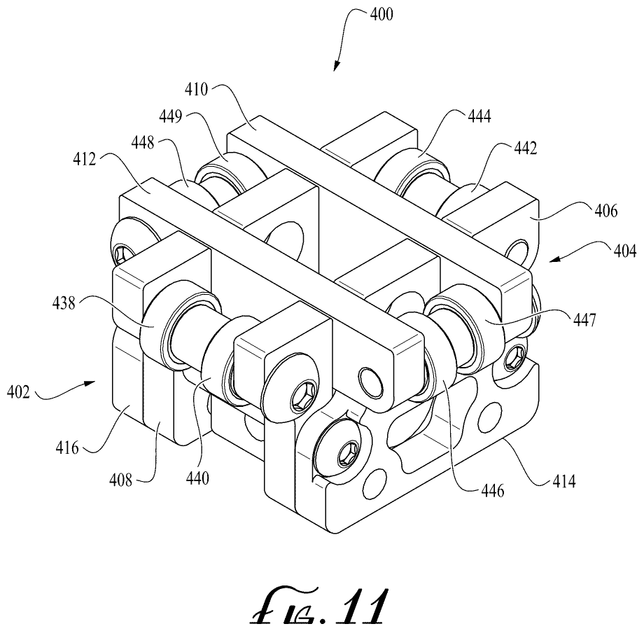

FIGS. 7-10 illustrate the embodiment of FIGS. 3-6 being installed within a first tube T1 by inserting the tube insertion portion 202 into the first tube end E1, with the bearing support portion 204 protruding from the first tube end E1. The tube insertion portion 202 of the bearing support 200 is slid into the tube end E1 until tubes holes H1 and H2 align with holes 270 and 272 of the tube insertion portion 202 (and tube hole H3 aligns with hole 282, etc.), respectively, so that fasteners can inserted through the first tube T1 and the tube insertion portion 202 to fasten the bearing support 200 to the first tube T1. In FIGS. 9 and 10, the first tube end E1 of the first tube T1 is shown inserted into a second tube T2 from the second tube end E2 in a telescoping arrangement, where the second tube T2 is larger in internal dimension than the first tube T1. A bearing cage 350 is fastened about the exterior of tube T1, where the first tube T1 is supported by the bearings (two bearings in parallel on each side and two bearings in parallel on the bottom side) mounted on the bearing cage 350. For example, of the visible bearings, bearings 352, 354 (and two bearings on the opposing side) roll on the side walls of the first tube, and bearing 356 (and a second bearing, not visible) roll on the bottom wall of the first tube T1, where all bearings aid in preventing the first tube T1 from coming into rubbing contacting the second tube T2. Another set of bearings can be mounted to the top of the bearing cage 350 if the orientation of the tubes T1, T2 is expected to rotate relative to gravity. FIG. 10 shows the first tube end E1 and the installed bearing support 200 about midway within the second tube T2. Bearings 244 and 248 are both in rolling contact with the first interior wall W1, and bearing 234 is in rolling contact with the second interior wall W2 (contiguous with and adjacent to the first interior wall W1), with the remainder of the bearings in rolling contact with their respective interior walls. In this way, the bearing mounted on the externally located bearing cage 350 and the bearings mounted on the internally located bearing support 200 work together to prevent the first tube T1 from contacting the second tube T2 and allow the first tube T1 to smoothly telescope in and out of the second tube T2. Although not shown, the second tube T2 can include mounted thereon a control motor and drive belt for controlling the telescoping movement of the first tube T1.

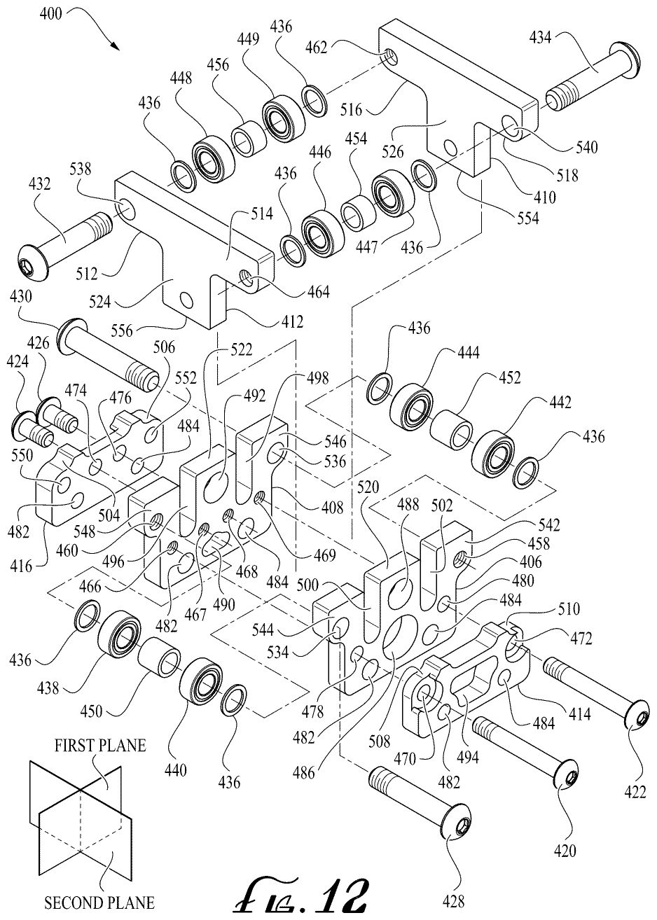

Turning to FIGS. 11 and 12, a bearing support 400 is illustrated for use with a yet again larger square tube compared to the above-described embodiments. This example embodiment is substantially similar to the above-described examples, in basic structure and operation, as discussed in the second embodiment above. The third bearing plate 410 is T-shaped, with a shoulder 516 extending to the viewer's left and parallel to a second plane, with shoulder 518 extending oppositely and parallel to the second plane, and a spacer extension 526 extending orthogonally from the shoulders 516, 518 downward and parallel to the first plane. Shoulder 516 includes a threaded hole 462 for receiving threadably therein screw 432. Shoulder 518 includes a through hole 540 for receiving therethrough screw 434. Bearings 446, 447 are separated by a sleeve 454 (i.e., a bushing, tube, plain bearing, or the like) and are surrounded by two shims 436. Screw 434 is inserted through hole 540, and, in this order, shim 436, bearing 447, sleeve 454, bearing 446, and shim 436 are placed in a stacked arrangement on the screw 434. Screw 434 is then loosely threaded into threaded hole 464 of the of the fourth bearing plate 412.

Similarly, the fourth bearing plate 412 is T-shaped, with a shoulder 512 extending to the viewer's left and parallel to a second plane, with shoulder 514 extending oppositely and parallel to the second plane, and a spacer extension 524 extending orthogonally from the shoulders 512, 514 downward and parallel to the first plane. Shoulder 514 includes threaded hole 464 for receiving threadably therein screw 434. Shoulder 518 includes a through hole 538 for receiving therethrough screw 432. Bearings 448, 449 are separated by a sleeve 456 and are surrounded by two shims 436. Screw 432 is inserted through hole 538, and, in this order, shim 436, bearing 448, sleeve 456, bearing 449, and shim 436 are placed in a stacked arrangement on the screw 432. Screw 432 is then loosely threaded into threaded hole 462 of the third bearing plate 410. This loose assembly of the third bearing plate 410 and the fourth bearing plate 412 is set aside in order to assemble the first bearing plate 406 and the second bearing plate 408 (the order of assembly of the two subassemblies can be reversed as well).

Somewhat similar to the bearing assembly of the third bearing plate 410 and the fourth bearing plate 412, the first bearing plate 406 and the second bearing plate 408 are spaced apart, parallel to the first plane, and have a stacked bearing assembly supported on a screw spanning the space between the two plates 406, 408. Regarding the first bearing plate 406, two plate locating notches 500 and 502 are formed vertically from the top edge of the first bearing plate 406, one spaced apart and parallel to the other, defining a spacer extension 520 therebetween in a W-like shape. Threaded hole 458 is formed through a first ear 542 (adjacent to and partially defined by notch 502) and through hole 534 is formed through a second ear 544 (adjacent to and partially defined by notch 500). Two block through holes 478, 480 and two tube fastener through holes 482 are formed through the first bearing plate 406. Plate locating notches 500 and 502 are configured to receive therein shoulders 514 and 518, respectively, when assembled. Lightning holes 486, 488 are centrally formed through the first bearing plate 406 for reducing weight. Spacer extension 520 extends upward and is defined between plate locating notches 500, 502.

The second bearing plate 408, like the first bearing plate 406, includes two plate locating notches 496 and 498 are formed vertically from the top edge of the second bearing plate 408, one spaced apart and parallel to the other, defining a spacer extension 522 therebetween in a W-like shape. Threaded hole 460 is formed through a second ear 548 (adjacent to and partially defined by notch 496) and through hole 536 is formed through a first ear 546 (adjacent to and partially defined by notch 498). Two tube fastener through holes 482, 484 are formed through the second bearing plate 408. Along a horizontal line, threaded through holes 466, 467, 468, 469 are formed through the second bearing plate 408. Plate locating notches 496 and 498 are configured to receive therein shoulders 512 and 516, respectively, when assembled. Lightning holes 490, 492 are centrally formed through the second bearing plate 408 for reducing weight. Spacer extension 522 extends upward and is defined between plate locating notches 496, 498.

A first end plate 414 includes countersunk holes 470, 472 for receiving therein block screws 420, 422, respectively. Further, through holes 482, 484 are formed through the first end plate 414 for receiving therethrough fasteners for attaching the bearing support 400 to a tube. Shoulder clearances 508, 510 are formed on the each of the top corners for providing clearance for shoulders 514, 518 of the fourth bearing plate 412 and the third bearing plate 410. Lightning hole 494 is centrally formed through the first end plate 414 for reducing weight.

A second end plate 416 includes countersunk holes 474, 476 (partially visible in this view) for receiving therein block screws 424, 426, respectively. Further, through holes 482, 484 are formed through the second end plate 414 for receiving therethrough fasteners for attaching the bearing support 400 to a tube. Shoulder clearances 504, 506 are formed on the each of the top corners for providing clearance for shoulders 512, 516 of the fourth bearing plate 412 and the third bearing plate 410. Additionally, through holes 550, 552 are formed through the second end plate 416 for providing clearance for the ends of screws 420, 422.

Bearings 444, 442 are separated by a sleeve 452 and are surrounded by two shims 436. Screw 430 is inserted through hole 536, and, in this order, shim 436, bearing 444, sleeve 452, bearing 442, and shim 436 are placed in a stacked arrangement on the screw 430. Screw 430 is then loosely threaded into threaded hole 458 of the first bearing plate 406.

Bearings 438, 440 are separated by a sleeve 450 and are surrounded by two shims 436. Screw 430 is inserted through hole 536, and, in this order, shim 436, bearing 444, sleeve 452, bearing 442, and shim 436 are placed in a stacked arrangement on the screw 430. Screw 430 is then loosely threaded into threaded hole 460 of the second bearing plate 408. Second end plate 416 is attached to the second bearing plate 408 by inserting screws 424, 426 through countersunk holes 550, 552, and threaded snugly into threaded holes 467, 468 of the second bearing plate 408. Likewise, first end plate 414 is attached to the first bearing plate 406 by inserting screws 420, 422 through countersunk holes 470, 472, and through holes 478, 480, and threaded loosely into threaded holes 466, 469 of the second bearing plate 408.

The subassembly of the third and fourth bearing plates 410, 412 can now be joined with the subassembly of the first and second bearing plates 406, 408. The first shoulder 516 and the second shoulder 518 of the third bearing plate 410 are dropped into plate locating notches 498 and 502, respectively. At the same time, the first shoulder 512 and the second shoulder 514 of the fourth bearing plate 412 are dropped into plate locating notches 496 and 500, respectively. Screws 420, 422, 428, 430 can be tightened to firm up the assembly, yet allow for slight adjustments. The termini 554, 556 of the third bearing plate 410 and the fourth bearing plate 412, respectively, are leveled with the bottom edges of the first and second bearing plates 406, 408 (i.e., by setting on a support surface or held in hand). Then, screws 420, 422, 428, 430 are further tightened to clamp the spacer extension 524, 526 between the inner surfaces of the first and second bearing plates 406, 408, being held therebetween in frictional engagement. Although, frictional engagement is described herein as the methos to join at least two bearing plates in an orthogonal relationship, this can be achieved by other means of attachment, such as screws, interference fit joints, etc.

Aspects of the present specification may also be described as follows:
1. A bearing support comprising a first bearing plate having a first outer planar face and a first inner planar face each arranged parallel to a first plane, the first bearing plate having a first bearing support portion; a second plate having a second outer planar face and a second inner planar face arranged parallel to the first plane and space apart from the first bearing plate with the first inner planar face and the second inner planar face each arranged toward the other; and a third bearing plate having a third outer planar face and third inner planar face each arranged parallel to a second plane that is perpendicular to the first plane, the third bearing plate having a third spacer portion extending from a third bearing support portion; wherein, in an assembly, the first bearing plate is fastened with the second plate with the third spacer portion positioned therebetween, the first inner planar face facing and parallel to the second inner planar face, the third spacer portion held in frictional engagement within the assembly.
2. In one or more embodiments of the bearing support, a first bearing is supported at least in part on the first bearing plate at the first bearing support portion with a first axis of rotation of the first bearing arranged perpendicularly to the first inner planar face.
3. In one or more embodiments of the bearing support, the first bearing is supported between the first bearing plate and the second plate at a second bearing support portion with the first axis of rotation arranged perpendicularly to the second outer planar face and the second inner planar face.
4. In one or more embodiments of the bearing support, a second bearing is supported at least in part on the third bearing plate at the third bearing support portion with a second axis of rotation of the second bearing arranged perpendicularly to the to the third outer planar face, to the third inner planar face, and to the first axis of rotation of the first bearing.
5. In one or more embodiments of the bearing support, the first bearing plate further comprises a first insert portion from which the first bearing support portion extends and the second plate further comprises a second insert portion from which the second bearing support portion extends, wherein, in the assembly, the first insert portion, the second insert portion, and the third spacer portion form an insert block assembly configured to be inserted within and secured to a first tube end of a first tube with the first bearing support portion and the third bearing support portion protruding from the first tube.
6. In one or more embodiments of the bearing support, a first bearing is supported at least in part on the first bearing plate at the first bearing support portion with a first axis of rotation of the first bearing arranged perpendicularly to the first outer planar face and the first inner planar face; a second bearing is supported at least in part on the third bearing plate at the third bearing support portion with a second axis of rotation of the second bearing arranged perpendicularly to the to the third outer planar face, to the third inner planar face, and to the first axis of rotation of the first bearing; and the first bearing plate further comprises a first insert portion from which the first bearing support portion extends and the second plate further comprises a second insert portion, wherein, in the assembly, the first insert portion, the second insert portion, and the third spacer portion form an insert block assembly configured to be inserted within and secured to a first tube end of a first tube with the first bearing support portion and the third bearing support portion protruding from the first tube.
7. In one or more embodiments of the bearing support, the first tube end of the first tube is inserted into a second tube end of a second tube with the first bearing in rolling engagement with a first interior wall of the second tube and the second bearing in rolling engagement with a second interior wall of the second tube adjacent to the first interior wall.
8. In one or more embodiments of the bearing support, a fourth bearing plate having a fourth outer planar face and fourth inner planar face each arranged parallel to the third plane, the fourth bearing plate having a fourth spacer portion extending from a fourth bearing support portion; wherein, in the assembly, the fourth spacer portion is sandwiched between the first bearing plate and the second plate with the first inner planar face and the second inner planar face contacting the fourth spacer portion of the fourth bearing plate, the fourth bearing plate arranged parallel to the third bearing plate.
9. In one or more embodiments of the bearing support, the spacer portion of the third bearing plate is held between the first bearing plate and the second plate with the first inner planar face and the second inner planar face contacting the third spacer portion of the third bearing plate in frictional engagement.
10. In one or more embodiments of the bearing support, the second bearing plate further comprises a second bearing support portion, the first bearing is supported between the first bearing plate and the second plate at the second bearing support portion with the first axis of rotation of the first bearing arranged perpendicularly to the first inner planar face.
11. In one or more embodiments of the bearing support, further comprising an insert plate, the first bearing plate further comprises a first insert portion from which the first bearing support portion extends and the second plate further comprises a second insert portion, wherein, in the assembly, the first insert portion, the second insert portion, the third spacer portion, and the insert plate an insert block assembly.
12. In one or more embodiments of the bearing support, the third bearing support portion of the third bearing plate includes a first shoulder portion extending oppositely from a second shoulder portion, the first bearing support portion of the first bearing plate includes a first notch configured to receive therein the first shoulder portion, and the second plate includes a second notch configured to receive therein the second shoulder portion.
13. A bearing support comprising a first bearing plate having a first outer planar face and a first inner planar face each arranged parallel to a first plane, the first bearing plate having a first bearing support portion; a second plate having a second outer planar face and a second inner planar face arranged parallel to the first plane and space apart from the first bearing plate with the first inner planar face and the second inner planar face each arranged toward the other; and a third bearing plate having a third outer planar face and third inner planar face each arranged parallel to a third plane that is perpendicular to the first plane, the third bearing plate having a third spacer portion extending from a third bearing support portion; a first bearing configured to be mounted at least in part on the first bearing plate at the first bearing support portion with a first axis of rotation of the first bearing arranged perpendicularly to the first inner planar face; a second bearing configured to be mounted at least in part on the third bearing plate at the third bearing support portion with a second axis of rotation of the second bearing arranged perpendicularly to the to the third outer planar face, to the third inner planar face, and to the first axis of rotation of the first bearing; wherein, in an assembly, the first bearing plate is fastened with the second plate with the third spacer portion positioned therebetween, the first inner planar face facing and parallel to the second inner planar face, the third spacer portion held in frictional engagement within the assembly.
14. In one or more embodiments of the bearing support, the first bearing plate further comprises a first insert portion from which the first bearing support portion extends and the second plate further comprises a second insert portion from which the second bearing support portion extends, wherein, in the assembly, the first insert portion, the second insert portion, and the third spacer portion form an insert block assembly configured to be inserted within and secured to a first tube end of a first tube with the first bearing support portion and the third bearing support portion protruding from the first tube.
15. In one or more embodiments of the bearing support, the first bearing is supported between the first bearing plate and the second plate at a second bearing support portion with the first axis of rotation arranged perpendicularly to the second outer planar face and the second inner planar face.
16. In one or more embodiments of the bearing support, further comprises an insert plate, the first bearing plate further comprises a first insert portion from which the first bearing support portion extends and the second plate further comprises a second insert portion, wherein, in the assembly, the first insert portion, the second insert portion, the third spacer portion, and the insert plate an insert block assembly.
17. In one or more embodiments of the bearing support, the third bearing support portion of the third bearing plate includes a first shoulder portion extending oppositely from a second shoulder portion, the first bearing support portion of the first bearing plate includes a first notch configured to receive therein the first shoulder portion, and the second plate includes a second notch configured to receive therein the second shoulder portion.
18. In one or more embodiments of the bearing support, the first tube end of the first tube is inserted into a second tube end of a second tube with the first bearing in rolling engagement with a first interior wall of the second tube and the second bearing in rolling engagement with a second interior wall of the second tube adjacent to the first interior wall.
19. A bearing support comprising a first bearing plate having a first outer planar face and a first inner planar face each arranged parallel to a first plane, the first bearing plate having a first bearing support portion having a first notch; a second plate having a second outer planar face and a second inner planar face arranged parallel to the first plane and space apart from the first bearing plate with the first inner planar face and the second inner planar face each arranged toward the other, the second plate further including a second notch; and a third bearing plate having a third outer planar face and third inner planar face each arranged parallel to a third plane that is perpendicular to the first plane, the third bearing plate having a third spacer portion extending from a third bearing support portion with a first shoulder portion extending oppositely from a second shoulder portion, the first shoulder configured to fit within the first notch and the second shoulder configured to fit within the second notch; wherein, in an assembly, the first bearing plate is fastened with the second plate with the third spacer portion positioned therebetween, the first inner planar face facing and parallel to the second inner planar face, the third spacer portion held within the assembly.
20. In one or more embodiments of the bearing support, a first bearing is configured to be mounted at least in part on the first bearing plate at the first bearing support portion with a first axis of rotation of the first bearing arranged perpendicularly to the first inner planar face; and a second bearing is configured to be mounted at least in part on the third bearing plate at the third bearing support portion with a second axis of rotation of the second bearing arranged perpendicularly to the to the third outer planar face, to the third inner planar face, and to the first axis of rotation of the first bearing.

In closing, it is to be understood that, although aspects of the present specification are highlighted by referring to specific embodiments, one skilled in the art will readily appreciate that these disclosed embodiments are only illustrative of the principles of the subject matter disclosed herein. The specific embodiments are not intended to be exhaustive or to limit the invention to the precise forms disclosed. Therefore, it should be understood that the disclosed subject matter is in no way limited to a particular compound, composition, article, apparatus, methodology, and/or protocol, etc., described herein, unless expressly stated as such. In addition, those of ordinary skill in the art will recognize that certain changes, modifications, permutations, alterations, additions, subtractions and sub-combinations thereof can be made in accordance with the teachings herein without departing from the spirit of the present specification. It is therefore intended that the scope of the invention is not to be limited by this detailed description. Furthermore, it is intended that the following appended claims and claims hereafter introduced are interpreted to include all such changes, modifications, permutations, alterations, additions, subtractions and sub-combinations as are within their true spirit and scope.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified, thus fulfilling the written description of all Markush groups used in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Unless otherwise indicated, all numbers expressing a characteristic, item, quantity, parameter, property, term, and so forth used in the present specification and claims are to be understood as being modified in all instances by the term “about” and/or “approximately.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as, e.g., “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising”, variations thereof such as, e.g., “comprise” and “comprises”, and equivalent open-ended transitional phrases thereof like “including,” “containing” and “having”, encompass all the expressly recited elements, limitations, steps, integers, and/or features alone or in combination with unrecited subject matter; the named elements, limitations, steps, integers, and/or features are essential, but other unnamed elements, limitations, steps, integers, and/or features may be added and still form a construct within the scope of the claim. Thus, the meaning of the open-ended transitional phrase “comprising” is being defined as encompassing all the specifically recited elements, limitations, steps and/or features as well as any optional, additional unspecified ones.

Lastly, the terminology used herein is for the purpose of describing particular embodiments only and is not intended to limit the scope of the present invention, which is defined solely by the claims. Accordingly, the present invention is not limited to that precisely as shown and described.

What is claimed is:

1. A bearing support comprising:
a first bearing plate having a first outer planar face and a first inner planar face each arranged parallel to a first plane, the first bearing plate having a first bearing support portion;
a second plate having a second outer planar face and a second inner planar face arranged parallel to the first plane and space apart from the first bearing plate with the first inner planar face and the second inner planar face each arranged toward the other; and
a third bearing plate having a third outer planar face and third inner planar face each arranged parallel to a second plane that is perpendicular to the first plane, the third bearing plate having a third spacer portion extending from a third bearing support portion;
wherein, in an assembly, the first bearing plate is fastened with the second plate with the third spacer portion positioned therebetween, the first inner planar face facing and parallel to the second inner planar face, the third spacer portion held in frictional engagement within the assembly.

2. The bearing support of claim 1 wherein a first bearing is supported at least in part on the first bearing plate at the first bearing support portion with a first axis of rotation of the first bearing arranged perpendicularly to the first inner planar face.

3. The bearing support of claim 2 wherein the first bearing is supported between the first bearing plate and the second plate at a second bearing support portion with the first axis of rotation arranged perpendicularly to the second outer planar face and the second inner planar face.

4. The bearing support of claim 2 wherein a second bearing is supported at least in part on the third bearing plate at the third bearing support portion with a second axis of rotation of the second bearing arranged perpendicularly to the to the third outer planar face, to the third inner planar face, and to the first axis of rotation of the first bearing.

5. The bearing support of claim 2 wherein the first bearing plate further comprises a first insert portion from which the first bearing support portion extends and the second plate further comprises a second insert portion from which the second bearing support portion extends, wherein, in the assembly, the first insert portion, the second insert portion, and the third spacer portion form an insert block assembly configured to be inserted within and secured to a first tube end of a first tube with the first bearing support portion and the third bearing support portion protruding from the first tube.

6. The bearing support of claim 1 wherein:
a first bearing is supported at least in part on the first bearing plate at the first bearing support portion with a first axis of rotation of the first bearing arranged perpendicularly to the first outer planar face and the first inner planar face;
a second bearing is supported at least in part on the third bearing plate at the third bearing support portion with a second axis of rotation of the second bearing arranged perpendicularly to the to the third outer planar face, to the third inner planar face, and to the first axis of rotation of the first bearing; and
the first bearing plate further comprises a first insert portion from which the first bearing support portion extends and the second plate further comprises a second insert portion, wherein, in the assembly, the first insert portion, the second insert portion, and the third spacer portion form an insert block assembly configured to be inserted within and secured to a first tube end of a first tube with the first bearing support portion and the third bearing support portion protruding from the first tube.

7. The bearing support of claim 6 wherein the first tube end of the first tube is inserted into a second tube end of a second tube with the first bearing in rolling engagement with a first interior wall of the second tube and the second bearing in rolling engagement with a second interior wall of the second tube adjacent to the first interior wall.

8. The bearing support of claim 1 further comprising:
a fourth bearing plate having a fourth outer planar face and fourth inner planar face each arranged parallel to the third plane, the fourth bearing plate having a fourth spacer portion extending from a fourth bearing support portion;
wherein, in the assembly, the fourth spacer portion is sandwiched between the first bearing plate and the second plate with the first inner planar face and the second inner planar face contacting the fourth spacer portion of the fourth bearing plate, the fourth bearing plate arranged parallel to the third bearing plate.

9. The bearing support of claim 1 wherein the spacer portion of the third bearing plate is held between the first bearing plate and the second plate with the first inner planar face and the second inner planar face contacting the third spacer portion of the third bearing plate in frictional engagement.

10. The bearing support of claim 1 wherein the second bearing plate further comprises a second bearing support portion, the first bearing is supported between the first bearing plate and the second plate at the second bearing support portion with the first axis of rotation of the first bearing arranged perpendicularly to the first inner planar face.

11. The bearing support of claim 1 further comprising an insert plate, the first bearing plate further comprises a first insert portion from which the first bearing support portion extends and the second plate further comprises a second insert portion, wherein, in the assembly, the first insert portion, the second insert portion, the third spacer portion, and the insert plate an insert block assembly.

12. The bearing support of claim 1 wherein the third bearing support portion of the third bearing plate includes a first shoulder portion extending oppositely from a second shoulder portion, the first bearing support portion of the first bearing plate includes a first notch configured to receive therein the first shoulder portion, and the second plate includes a second notch configured to receive therein the second shoulder portion.

13. A method of telescoping an appendage of a robotic device comprising:
mounting a first bearing to a first bearing support portion of a first bearing plate;
mounting a second bearing to a second bearing support portion of a second bearing plate;
arranging an insert portion of the second bearing plate between the first bearing plate and a third plate, with the first bearing plate spaced apart and parallel with the third plate, and the second bearing plate oriented orthogonally to the first bearing plate and the third plate with the second bearing support portion positioned above the first bearing plate and the third plate;
fastening a third tube insertion portion of a third bearing plate to a first tube insertion portion of a first plate to firmly clamp the insert portion of the second bearing plate therebetween to create a bearing support having a bearing support portion and a tube insertion portion;
inserting the tube insertion portion of the bearing support into a first end of a first tube with the bearing supporting portion protruding from the first end; and
inserting the first end of the first tube into a second tube so that the first bearing is in rolling engagement with a first wall of the second tube and the second bearing is in rolling engagement with a second wall of the second tube to create the appendage, the second wall orthogonal and adjacent to the first wall, to permit telescoping between the first tube and the second tube.

14. The method of claim 13 wherein mounting the first bearing to the first bearing support portion further comprises:
mounting a third bearing to the first bearing support portion of the first bearing plate;
mounting a fourth bearing to the second bearing support portion of the second bearing plate, wherein the third bearing is in rolling engagement with a third wall of the second tube opposite the first wall, and the fourth bearing is in rolling engagement with a fourth wall of the second tube opposite the second wall.

15. The method of claim 13 wherein the insert portion of the second bearing plate is held in frictional engagement between the first bearing plate and the second bearing plate.

16. The method of claim 13 wherein the third bearing plate is an end plate configured to increase a dimensional size of the tube insertion portion.

17. The method of claim 13 wherein a spacer plate is sandwiched within the tube insert portion and is configured to increase a dimensional size of the tube insertion portion.

18. A bearing support comprising:
a first bearing plate having a first outer planar face and a first inner planar face each arranged parallel to a first plane, the first bearing plate having a first bearing support portion having a first notch;
a second plate having a second outer planar face and a second inner planar face arranged parallel to the first plane and space apart from the first bearing plate with the first inner planar face and the second inner planar face each arranged toward the other, the second plate further including a second notch; and
a third bearing plate having a third outer planar face and third inner planar face each arranged parallel to a third plane that is perpendicular to the first plane, the third bearing plate having a third spacer portion extending from a third bearing support portion with a first shoulder portion extending oppositely from a second shoulder portion, the first shoulder configured to fit within the first notch and the second shoulder configured to fit within the second notch;
wherein, in an assembly, the first bearing plate is fastened with the second plate with the third spacer portion positioned therebetween, the first inner planar face facing and parallel to the second inner planar face, the third spacer portion held within the assembly.

19. The bearing support of claim 18 further comprising:
a first bearing configured to be mounted at least in part on the first bearing plate at the first bearing support portion with a first axis of rotation of the first bearing arranged perpendicularly to the first inner planar face; and
a second bearing configured to be mounted at least in part on the third bearing plate at the third bearing support portion with a second axis of rotation of the second bearing arranged perpendicularly to the to the third outer planar face, to the third inner planar face, and to the first axis of rotation of the first bearing.

20. The bearing support of claim 19 wherein a second bearing is supported at least in part on the third bearing plate at the third bearing support portion with a second axis of rotation of the second bearing arranged perpendicularly to the to the third outer planar face, to the third inner planar face, and to the first axis of rotation of the first bearing.
